(19) United States
(12) Patent Application Publication
(10) Pub. No.: US 2024/0088386 A1
(43) Pub. Date: Mar. 14, 2024

(54) SECONDARY BATTERY SYSTEM AND MANUFACTURING METHOD OF SECONDARY BATTERY

(71) Applicant: TOYOTA JIDOSHA KABUSHIKI KAISHA, Toyota-shi (JP)

(72) Inventors: Hideaki NISHIMURA, Sunto-gun (JP); Fuminori MIZUNO, Miyoshi-shi (JP); Keiichi MINAMI, Tagata-gun (JP); Azusa NAKANISHI, Susono-shi (JP)

(73) Assignee: TOYOTA JIDOSHA KABUSHIKI KAISHA, Toyota-shi (JP)

(21) Appl. No.: 18/354,836

(22) Filed: Jul. 19, 2023

(30) Foreign Application Priority Data
Sep. 12, 2022 (JP) 2022-144695

(51) Int. Cl. H01M 4/58; H01M 10/635; H01M 50/569

(52) U.S. Cl. CPC H01M 4/5825; H01M 10/635; H01M 50/569; H01M 2300/0068

(57) ABSTRACT

A secondary battery system of the present disclosure includes a secondary battery and a heating device, wherein the secondary battery includes a positive electrode and a negative electrode, and one or both of the positive electrode and the negative electrode include an active material and a granulated body, the active material includes a material whose volume changes with charge and discharge of the secondary battery, the granulated body includes an inorganic solid electrolyte and an alkali metal-containing salt, and a target heated by the heating device includes the alkali metal-containing salt.

### CROSS-REFERENCE TO RELATED APPLICATION

This application claims priority to Japanese Patent Application No. 2022-144695 filed on Sep. 12, 2022, incorporated herein by reference in its entirety.

### BACKGROUND

### 1. Technical Field

The present application discloses a secondary battery system and a manufacturing method of the secondary battery.

### 2. Description of Related Art

Japanese Unexamined Patent Application Publication No. 2019-096541 (JP 2019-096541 A) discloses an all-solid-state battery including a positive electrode active material layer and a negative electrode active material layer. One or both of the positive electrode active material layer and the negative electrode active material layer contain a predetermined amount of a Li containing salt, and the Li containing salt contains tetrabutylammonium bis(trifluoromethanesulfonyl)imide and lithium bis(trifluoromethanesulfonyl)imide.

### SUMMARY

The volume of some active materials included in a positive electrode and a negative electrode changes as the battery is charged and discharged. When the volume of the active material changes as the battery is charged and discharged, a crack, a gap, and the like may occur in the positive electrode and the negative electrode, and the resistance of the battery is likely to increase. Such an issue is likely to occur particularly when an inorganic solid electrolyte is contained together with the active material in the positive electrode and the negative electrode.

The present application discloses the following embodiments as means for solving the above issue.

### First Aspect

A secondary battery system includes: a secondary battery including a positive electrode and a negative electrode; and a heating device.

One or both of the positive electrode and the negative electrode include an active material and a granulated body.

The active material contains a material of which volume changes as the secondary battery is charged and discharged.

The granulated body contains an inorganic solid electrolyte and an alkali metal-containing salt.

An object to be heated by the heating device includes the alkali metal-containing salt.

### Second Aspect

The secondary battery system according to the first aspect further includes a control device. When performance of the secondary battery is determined to be equal to or lower than a certain level, the control device controls heating by the heating device such that a temperature of the alkali metal-containing salt is equal to or higher than a melting point of the alkali metal-containing salt.

### Third Aspect

In the secondary battery system according to the second aspect, when the performance of the secondary battery is determined to exceed the certain level, the control device controls heating by the heating device such that the temperature of the alkali metal-containing salt is lower than the melting point of the alkali metal-containing salt.

### Fourth Aspect

The secondary battery system according to the second aspect or the third aspect further includes a voltage measurement device.

The voltage measurement device measures a voltage of the secondary battery.

The performance of the secondary battery is based on the voltage.

### Fifth Aspect

The secondary battery system according to the second aspect or the third aspect further includes a resistance measurement device.

The resistance measurement device measures a resistance of the secondary battery.

The performance of the secondary battery is based on the resistance.

### Sixth Aspect

In the secondary battery system according to any one of the first to fifth aspects, the alkali metal-containing salt has a melting point of 100° C. or less.

### Seventh Aspect

In the secondary battery system according to any one of the first to sixth aspects, the positive electrode contains the active material and the granulated body, and the active material contains S.

### Eighth Aspect

In the secondary battery system according to any one of the first to seventh aspects, the negative electrode contains the active material and the granulated body, and the active material contains Si.

### Ninth Aspect

In the secondary battery system according to any one of the first to eighth aspects, the inorganic solid electrolyte contains a sulfide.

### Tenth Aspect

In the secondary battery system according to any one of the first to ninth aspects, the alkali metal-containing salt includes a first cation and a second cation, the first cation is at least one selected from an ammonium ion, a phosphonium ion, a pyridinium ion, and a pyrrolidinium ion, and the second cation is an alkali metal ion.

### Eleventh Aspect

In the secondary battery system according to any one of the first to tenth aspects, the alkali metal-containing salt includes a first cation and a second cation, the first cation is a tetraalkylammonium ion, and the second cation is an alkali metal ion.

### Twelfth Aspect

In the secondary battery system according to any one of the first to eleventh aspects, the alkali metal-containing salt contains at least one anion selected from a group consisting of a halogen ion, a halide ion, a hydrogen sulfate ion, a sulfonylamide ion, and a complex ion containing H.

### Thirteenth Aspect

In the secondary battery system according to any one of the first to twelfth aspects, the alkali metal-containing salt contains one or both of a first anion and a second anion, the first anion is one or both of a halogen ion and a hydrogen sulfate ion, and the second anion is a sulfonylamide anion.

### Fourteenth Aspect

A manufacturing method of a secondary battery includes: obtaining a granulated body containing an inorganic solid electrolyte and an alkali metal-containing salt; obtaining an electrode composite by mixing the granulated body and an active material; and forming one of a positive electrode and a negative electrode using the electrode composite.

According to the secondary battery system of the present disclosure, even when a crack, a gap, or the like is generated in the positive electrode or the negative electrode due to a change in volume of the active material caused by charging and discharging of the secondary battery, and performance of the secondary battery is deteriorated, the crack or the gap can be repaired as the alkali metal-containing salt is liquefied and melt by heating by the heating device. Therefore, for example, the resistance of the secondary battery can be kept low.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows a configuration of a secondary battery system;

FIG. 2 shows an exemplary form of a granulated body; and

FIG. 3 shows an example of a control flow in the secondary battery system.

### DETAILED DESCRIPTION

### 1. Secondary Battery System

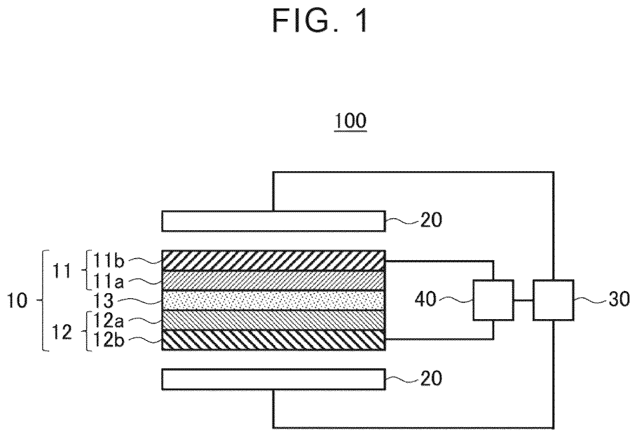

Hereinafter, an embodiment of a secondary battery system of the present disclosure will be described with reference to the drawings. As illustrated in FIG. 1, a secondary battery system 100 according to an embodiment includes a secondary battery 10 and a heating device 20. The secondary battery 10 includes a positive electrode 11 and a negative electrode 12. One or both of the positive electrode 11 and the negative electrode 12 includes an active material and a granulated body. The active material includes a material whose volume changes with charging and discharging of the secondary battery 10. The granulated body includes an inorganic solid electrolyte and an alkali metal-containing salt. The object to be heated by the heating device 20 includes the alkali metal-containing salt.

### 1.1 Secondary Battery

The secondary battery 10 includes a positive electrode 11 and a negative electrode 12. Further, the secondary battery 10 may include the electrolyte layer 13 between the positive electrode 11 and the negative electrode 12. Further, the secondary battery 10 may have a configuration (not shown). One or both of the positive electrode 11 and the negative electrode 12 includes an active material whose volume changes with charge and discharge, and a granulated body containing an inorganic solid electrolyte and an alkali metal-containing salt. That is, the positive electrode 11 may include a predetermined active material and a predetermined granulated body. Further, the negative electrode 12 may include a predetermined active material and a predetermined granulated body. In addition, both of the positive electrode 11 and the negative electrode 12 may include a predetermined active material and a predetermined granulated body.

### 1.1.1 Positive Electrode

As shown in FIG. 1, the positive electrode 11 may have a positive electrode active material layer 11a and a positive electrode current collector 11b contacting the layer 11a. The positive electrode active material layer 11a may include a predetermined active material and a predetermined granulated body.

The positive electrode active material 11a includes at least a positive electrode active material. The positive electrode active material layer 11a may include the granulated body described later. The positive electrode active material layer 11a may contain an electrolyte or an alkali metal-containing salt other than the granulated body described later. In addition, the positive electrode active material layer 11a may include a conductive auxiliary agent, a binder, and the like. Further, the positive electrode active material layer 11a may contain various additives. The content of the respective components in the positive electrode active material layer 11a may be appropriately determined according to the desired battery performance. For example, the total solid content of the positive electrode active material layer 11a as 100 wt %, the content of the positive electrode active material may be 40 wt % or more, 50 wt % or more, 60 wt % or more or 70 wt % or more, 100 wt % or less, 95 wt % or less or 90 wt % or less. Alternatively, the total amount of the positive electrode active material layer 11a may be 100% by volume, and the total amount of the positive electrode active material, the arbitrarily granulated body, the arbitrarily solid electrolyte other than the granulated body, the arbitrarily alkali metal-containing salt other than the granulated body, the arbitrarily conductive aid, and the arbitrarily binder may be 85% by volume or more, 90% by volume or more, or 95% by volume or more. The remainder may be a void or other component. The form of the positive electrode active material layer 11a is not particularly limited, and may be, for example, a sheet-like positive electrode active material layer having a substantially flat surface. The thickness of the positive electrode active material layer 11a is not particularly limited. The thickness of the positive electrode active material layer 11a may be, for example, 0.1 μm or more, 1 μm or more, or 10 μm or more, and may be 2 mm or less, 1 mm or less, or 500 μm or less.

As the positive electrode active material, one known as a positive electrode active material of a secondary battery may be used. For example, when a lithium-ion secondary battery is configured, a lithium-containing complex oxide (lithium cobaltate, lithium nickelate, LiNi_{1/3}Co_{1/3}Mn_{1/3}O₂, lithium manganate, a spinel-based lithium compound, or the like), a lithium-containing complex oxide (S alone, S compound), or the like may be employed as the positive electrode active material. The positive electrode active material may have a volume that changes with charge and discharge, for example, a positive electrode active material having an expansion coefficient of 5% or more (a positive electrode active material having a volume that changes by 5% or more in comparison between before and after expansion). Among them, the positive electrode active material containing S has a large volume change due to charging and discharging of the secondary battery 10. That is, when the positive electrode 11 includes an active material whose volume changes with charge and discharge, and a granulated body containing an inorganic solid electrolyte and an alkali metal-containing salt, and the active material includes S, it is considered that a more remarkable effect by the system 100 of the present disclosure can be obtained. Only one positive electrode active material may be used alone, or two or more positive electrode active materials may be used in combination. The positive electrode active material may be, for example, in a particulate form, and the size thereof is not particularly limited. The particles of the positive electrode active material may be solid particles, hollow particles, or particles having voids (porous particles). The particles of the positive electrode active material may be primary particles or secondary particles in which a plurality of primary particles is aggregated. The mean particle size (D50) of the particles of the positive electrode active material may be more than 1 nm, more than 5 nm, or more than 10 nm, or may be less than 500 μm, less than 100 μm, less than 50 μm, or less than 30 μm. The mean particle diameter (D50) is the particle diameter (median diameter) at an integrated value of 50% in the volume-based particle size distribution determined by the laser diffraction/scattering method.

The surface of the positive electrode active material may be covered with a protective layer containing an ion conductive oxide. That is, the positive electrode 11 may include a composite including a positive electrode active material and a protective layer provided on a surface thereof. As a result, a reaction or the like between the positive electrode active material and a sulfide (for example, a sulfide solid electrolyte, which will be described later) is easily suppressed. As the lithium ion conductive oxide, for example, Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, Li₂WO₄. The coverage (area ratio) of the protective layer may be, for example, 70% or more, 80% or more, or 90% or more. The thickness of the protective layer may be, for example, 0.1 nm or more or 1 nm or more, or may be 100 nm or less or 20 nm or less.

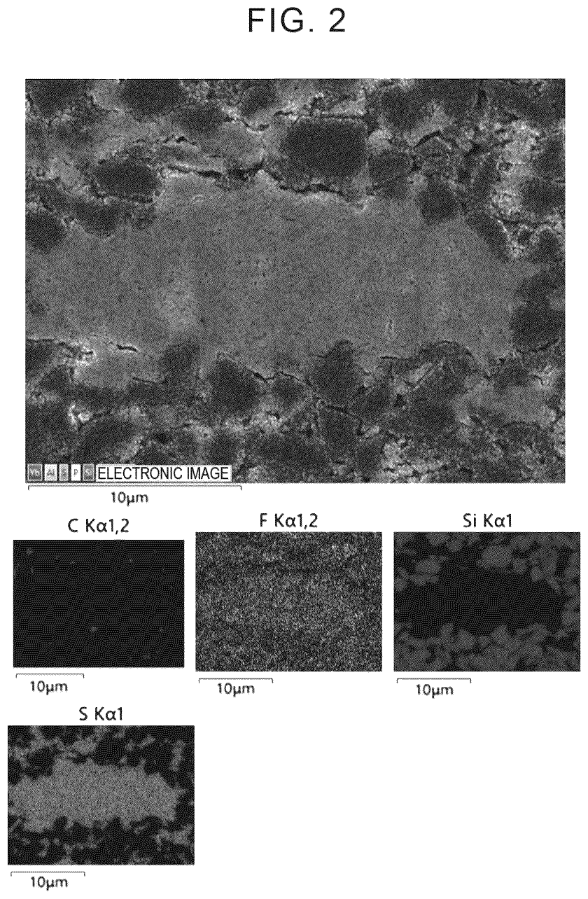

The granulated body includes at least an inorganic solid electrolyte and an alkali metal-containing salt. As described later, the granulated body can be obtained by mixing an inorganic solid electrolyte and an alkali metal-containing salt. In the present application, the term “granulated body” refers to a body in which at least an inorganic solid electrolyte and an alkali metal-containing salt are adhered to each other and constitute grains, and a specific form thereof is not particularly limited. In the granulated body, at least a portion of the surface of the inorganic solid electrolyte of the particulate may have been covered by an alkali metal-containing salt. The granulated body may be secondary particles of an inorganic solid electrolyte and an alkali metal-containing salt. FIG. 2 shows an example of the cross-sectional shape of the granulated body. In FIG. 2, a portion where the S presence region and the F presence region overlap (for example, flat particles in the center of the image) corresponds to a granulated body. The size of the granulated body is not particularly limited, and may be any size that can be included in the positive electrode 11 or the negative electrode 12. When the inorganic solid electrolyte and the alkali metal-containing salt constitute a granulated body, the alkali metal-containing salt is disposed in the vicinity of the inorganic solid electrolyte in the secondary battery. Thus, for example, even if a volume change of the active material occurs with charge and discharge of the secondary battery and a crack or a gap is generated in the inorganic solid electrolyte due to the volume change, the alkali metal-containing salt close to the inorganic solid electrolyte is heated and melted by the heating device described later, so that the crack or the gap generated in the inorganic solid electrolyte can be repaired by the alkali metal-containing salt.

The inorganic solid electrolyte is, for example, oxide solid electrolytes such as lithium lanthanum zirconate, LiPON, Li_{1+X}Al_{X}Ge_{2-X}(PO₄)₃, Li—SiO based glasses, Li—Al—S—O based glasses and sulfide solid electrolytes such as Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, Li₂S—P₂S₅—GeS₂. In particular, the performance of an inorganic solid electrolyte containing sulfide (sulfide solid electrolyte), and an inorganic solid electrolyte containing at least Li, S, and P as constituent elements among them, is particularly high. The inorganic solid electrolyte may be amorphous or may be crystalline. The inorganic solid electrolyte may be in the form of particles, for example, as long as it constitutes a granulated body together with an alkali metal-containing salt to be described later. Only one type of solid electrolyte may be used alone, or two or more types may be used in combination.

The alkali metal-containing salt is a salt containing at least an alkali metal ion as a cation. The type of the alkali metal ion is selected according to the type of the carrier ion of the secondary battery, and may be a lithium ion, a sodium ion, a potassium ion, or a cesium ion. For example, when the secondary battery is a lithium ion battery, the alkali metal-containing salt is a Li containing salt containing at least lithium ions as cations. The alkali metal-containing salt has a melting point and can be melted by being heated to the melting point or higher. The melting point of the alkali metal-containing salt may be appropriately selected in consideration of heat resistance and the like of the material constituting the secondary battery. If the melting point of the alkali metal-containing salt is too high, the temperature of the alkali metal-containing salt may be higher than or equal to the melting point, and if the alkali metal-containing salt is heated by the heating device 20, there is a possibility that the material constituting the battery may be adversely affected (e.g., the seal portion of the laminate film may be deteriorated). For example, the alkali metal-containing salt may have a melting point of 100° C. or less, 80° C. or less, or 60° C. or less. The lower limit of the melting point of the alkali metal-containing salt is not particularly limited. The alkali metal-containing salt may be a solid that is less than the melting point when heating by the heating device 20 is not performed. For example, the melting point of the alkali metal-containing salt may be 20° C. or higher, 25° C. or higher, 30° C. or higher, 35° C. or higher, 40° C. or higher, 45° C. or higher, or 50° C. or higher. The alkali metal-containing salt may be present in a particulate form in the granulated body before being heated by the heating device 20, may be present coated on the surface of the inorganic solid electrolyte, or may be present in a form other than these. The size of the alkali metal-containing salt is not particularly limited. The mean particle diameter (D50) of the particles of the alkali metal-containing salt may be, for example, not less than 1 nm, not less than 5 nm, or not less than 10 nm, and may be not more than 500 μm, not more than 100 μm, not more than 50 μm, or not more than 30 km.

The alkali metal-containing salt may have a first cation and a second cation. The first cation may be at least one selected from the ammonium ion, phosphonium ion, pyridinium ion, and pyrrolidinium ion. The second cation may be an alkali metal ion, in embodiments, a lithium ion. The first cation may be a tetraalkylammonium ion. The second cation may be an alkali metal ion, in embodiments, a lithium ion. If the alkali metal-containing salt has a first cation, it is likely to have a low melting point as compared to the case without the first cation.

Specific examples of the first cation include the following.
Tetrahexylammonium ion, N(C₆H₁₃)₄³⁰
Tetraoctylammonium ion, N(C₈H₁₇)₄⁺
Tetrabutylammonium ion, N(C₄H₉)₄⁺
Tetraethylammonium ion, N(C₂H₅)₄⁺
Tetraamylammonium ion, N(C₅H₁₁)₄⁺
Tetradecylammonium ion, N(C₁₀H₂₁)₄+
Ethyldimethylphenylethyl ion, N(CH₃)₂(C₂H₅)(C₂H₅C₆H₅)⁺
1-methyl-1-propylpiperidinium ion, (CH₃)(C₃H₇)N(C₅H₁₀)⁺
Amyltriethylammonium ion, N(C₂H₄)₃(C₅H₁₁)⁺
Methyl trioctylammonium ion, N(CH₃)(C₈H₁₇)₃⁺

The molar ratio of the first cation and the second cation constituting the alkali metal-containing salt is not particularly limited. When the alkali metal-containing salt has both the first cation and the second cation, the melting point of the alkali metal-containing salt is lower than when the alkali metal-containing salt has each of the first and second cations alone. The molar ratio of the second cation to the first cation (the second cation/the first cation) may be 0.05 or more and 19.0 or less from the viewpoint of greatly lowering the melting point of the alkali metal-containing salt and further enhancing the alkali metal ion conductivity. The molar ratio may be 0.1 or more, 0.2 or more, 0.3 or more, 0.4 or more, 0.5 or more, 0.6 or more, 0.7 or more, 0.8 or more, 0.9 or more, or 1.0 or more. The molar ratio may be 10.0 or less, 9.5 or less, 9.0 or less, 8.5 or less, 8.0 or less, 7.5 or less, 7.0 or less, 6.5 or less, 6.0 or less, 5.5 or less, or 5.0 or less. Even if the molar ratio of the second cation to the first cation constituting the alkali metal-containing salt is 1.0 or more (for example, the concentration of the alkali metal ion in the total cation is 50 mol % or more) and high concentration, the melting point of the alkali metal-containing salt is sufficiently low, and may be, for example, 100° C. or less, 80° C. or less, or 60° C. or less.

The cation constituting the alkali metal-containing salt may consist only of the first cation and the second cation, or may contain other cations different from the first cation and the second cation. Examples of the other cations include ions containing a poor metal element. Examples of the poor metal include Al and Ga. The total ratio of the first cation and the second cation to the entire cation constituting the alkali metal-containing salt may be 50 mol % or more, 60 mol % or more, 70 mol % or more, 80 mol % or more, 90 mol % or more, 95 mol % or more, 99 mol % or more, or 100 mol %

The alkali metal-containing salt may have various anions. For example, the alkali metal-containing salt may have at least one anion selected from a halogen ion, a halide ion, a hydrogen sulfate ion, a sulfonylamide ion, and a complex ion containing H. Alternatively, the alkali metal-containing salt may have one or both of the first anion and the second anion. The first anion may be one or both of a halogen ion and a hydrogen sulfate ion. The second anion may be a sulfonylamide anion. According to the present inventor's new knowledge, when the alkali metal-containing salt has the above-described anion, particularly when the alkali metal-containing salt has one or both of the halogen ion and the hydrogen sulfate ion, and particularly when the alkali metal-containing salt has the halogen ion, the melting point of the alkali metal-containing salt tends to decrease specifically. Further, according to the new knowledge of the present inventors, even when the alkali metal-containing salt has a sulfonylamide anion, the melting point of the alkali metal-containing salt tends to decrease specifically. Further, according to the new knowledge of the present inventors, when the alkali metal-containing salt has a plurality of types of anions, for example, when the alkali metal-containing salt has a first anion that is one or both of a halogen ion and a hydrogen sulfate ion, and a second anion that is a sulfonylamide anion, the melting point of the alkali metal-containing salt tends to specifically decrease.

The halogen ion may be, for example, one or both of a bromine ion and a chloride ion.

Examples of the sulfonylamide anion include a trifluoromethanesulfonylamide anion (TFSA anion, (CF₃SO₂)₂N⁻), a fluorosulfonylamide anion (FSA anion, (FSO₂)₂N⁻), a fluorosulfonyl (trifluoromethanesulfonyl) amide anion (FTA anion, FSO₂(CF₃SO₂)N⁻), and the like. The sulfonylamide anion may be only one kind or may be a combination of two or more kinds. Among the sulfonylamide anions, TFSA anions are low in polarity and particularly low in reactivity with other batteries. In this regard, when the alkali-metal-containing salt has TFSA anions, the alkali metal-containing salt is more likely to be suppressed from reacting with other battery materials.

The complex ion containing H may have, for example, an element M containing at least one of a non-metal element and a metal element, and H bonded to the element M. Further, the complex ion containing H may be bonded to each other through a covalent bond between the element M as a central element and H surrounding the element M. The complex ion containing H may be represented by (MₘHₙ)^{α-}). In this case, m is an arbitrary positive number, and n and a may take an arbitrary positive number depending on m and the equivalent number of the element M. The element M may be a non-metal element or a metal element capable of forming a complex ion. For example, the element M may include at least one of B, C, and N as a non-metallic element, and may include B. Further, for example, the element M may include at least one of Al, Ni and Fe as the metallic element. In particular, when the complex ion contains B or C and B, higher ion conductivity is easily ensured. Specific examples of complex ions containing H include (CB₉H₁₀)⁻, (CB₁₁H₁₂)⁻, (B₁₀H₁₀)²⁻, (B₁₂H₁₂)²⁻, (BH₄)⁻, (NH₂)⁻, and (AlH₄)⁻, and combinations thereof. In particular, when (CB₉H₁₀)⁻, (CB₁₁H₁₂)⁻, or a combination thereof is used, higher ionic conductivity is likely to be ensured.

When the alkali metal-containing salt has a first anion and a second anion, the molar ratio of the first anion and the second anion is not particularly limited. The molar ratio of the second anion to the first anion (second anion/first anion) may be greater than 0 and less than or equal to 19.0. The molar ratio may be 0.1 or more, 0.2 or more, 0.3 or more, 0.4 or more, or 0.5 or more, and may be 10.0 or less, 9.5 or less, 9.0 or less, 8.5 or less, 8.0 or less, 7.5 or less, 7.0 or less, 6.5 or less, 6.0 or less, 5.5 or less, or 5.0 or less.

The alkali metal-containing salt may contain other anions different from the above-exemplified anions (at least one anion selected from a halogen ion, a halide ion, a hydrogen sulfate ion, a sulfonylamide ion, and a complex ion containing H). The total proportion of the above-exemplified anions in the total of the anions constituting the alkali metal-containing salt may be 50 mol % or more, 60 mol % or more, 70 mol % or more, 80 mol % or more, 90 mol % or more, 95 mol % or more, 99 mol % or more, or 100 mol %.

FIG. 1 shows an example of the composition of an alkali metal-containing salt found by the present inventors and the melting point thereof.

### (1) AmTEA-TFSA+LI·TFSA

First cation: N(C₂H₅)₃(C₅H₁₁)⁺
Second cation: Li⁺
Anions: TFSA⁻
Molar ratio of the first cation to the second cation: 1.0
Melting point: about 50° C.

### (2) MTOA·TFSA+LI·TFSA

First cation: N(CH₃)(C₈H₁₇)₃⁺
Second cation: Li⁺
Anions: TFSA⁻
Molar ratio of the first cation to the second cation: 1.0
Melting point: about 50° C.

### (3) TAmA·Br+LI·TFSA

First cation: N(C₅H₁₁)₄+
Second cation: Li⁺
First anion: Br
Second anion: TFSA⁻
Molar ratio of the first cation to the second cation: 1.0
Molar ratio of the first anion to the second anion: 1.0
Melting point: about 30° C.

### (4) TBA·TFSA+LI·TFSA

First cation: N(C₄H₉)₄⁺
Second cation: Li⁺
Anions: TFSA⁻
Molar ratio of the first cation to the second cation: 1.0
Melting point: about 60° C.

Examples of the conductive auxiliary agent include carbon materials such as gas phase carbon fibers (VGCF), acetylene black (AB), Ketjen black (KB), carbon nanotubes (CNT), and carbon nanofibers (CNF); and metallic materials such as nickel, aluminum, and stainless steel. The conductive aid may be, for example, in the form of particles or fibers, and its size is not particularly limited. Only one type of conductive aid may be used alone, or two or more types may be used in combination.

Examples of the binder include a butadiene rubber (BR)-based binder, a butylene rubber (IIR)-based binder, an acrylate-butadiene rubber (ABR)-based binder, a styrene-butadiene rubber (SBR)-based binder, a polyvinylidene fluoride (PVdF)-based binder, and a polytetrafluoroethylene (PTFE)-based binder and a polyimide (PI)-based binder. Only one type of conductive aid may be used alone, or two or more types may be used in combination.

The positive electrode current collector 11b may be any of those generally used as a positive electrode current collector of a secondary battery. The positive electrode current collector 11b may be a foil, a plate, a mesh, a punching metal, a foam, or the like. The positive electrode current collector 11b may be formed of a metal foil or a metal mesh. In particular, a metal foil is excellent in handleability and the like. The positive electrode current collector 11b may be formed of a plurality of foils. The positive electrode current collector 11b may be made of Cu, Ni, Cr, Au, Pt, Ag, Al, Fe, Ti, Zn, Co, stainless-steel, or the like. In particular, from the viewpoint of ensuring oxidation resistance or the like, the positive electrode current collector 11b may contain Al. The positive electrode current collector 11b may have a plurality of coating layers for adjusting the resistivity thereof. The positive electrode current collector 11b may be formed by plating or depositing the metal on a metal foil or a base material. When the positive electrode current collector 11b is formed of a plurality of metal foils, some layers may be provided between the plurality of metal foils. The thickness of the positive electrode current collector is not particularly limited. For example, the thickness may be 0.1 μm or more or 1 μm or more, or may be 1 mm or less or 100 μm or less.

### 1.1.2 Negative Electrode

As shown in FIG. 1, the negative electrode 12 may have a negative electrode active material layer 12a and a negative electrode current collector 12b contacting the layer 12a. The negative electrode active material layer 12a may include a predetermined active material and a predetermined granulated body.

The negative electrode active material 12a includes at least a negative electrode active material. The negative electrode active material 12a may include the above-described granulated body. In addition, the negative electrode active material 12a may contain an electrolyte or an alkali metal-containing salt other than the above-described granulated body. In addition, the negative electrode active material 12a may include a conductive auxiliary agent, a binder, and the like. Further, the negative electrode active material layers 12a may contain various additives. The content of the respective components in the negative electrode active material layer 12a may be appropriately determined according to the desired battery performance. For example, the entire solids of the negative electrode active material layer 12a as 100 wt %, the content of the negative electrode active material is 40 wt % or more, 50 wt % or more, may be 60 wt % or 70 wt % or more, 100 wt % or less, 95 wt % or 90 wt % or less it may be. Alternatively, the negative electrode active material layer 12a may be 100% by volume, and the negative electrode active material, optionally the granulated body, optionally the solid electrolyte other than the granulated body, optionally the alkali metal-containing salt other than the granulated body, optionally the conductive auxiliary agent, and optionally the binder may be contained in a total amount of 85% by volume or more, 90% by volume or more, or 95% by volume or more. The remainder may be a void or other component. The form of the negative electrode active material layer 12a is not particularly limited, and may be, for example, a sheet-like negative electrode active material layer having a substantially flat surface. The thickness of the negative electrode active material layer 12a is not particularly limited, and may be, for example, 0.1 μm or more, 1 μm or more, or 10 μm or more, and may be 2 mm or less, 1 mm or less, or 500 μm or less.

As the negative electrode active material, a material known as a negative electrode active material of a secondary battery may be used. For example, when a lithium-ion secondary battery is configured, at least one selected from the group consisting of a negative electrode active material containing Si (a single Si substance, a Si alloy, a Si compound), a material containing carbon (graphite, hard carbon, etc.), a material containing an oxide (lithium titanate, etc.), and a material containing Li (metallic lithium, lithium alloy, etc.) may be employed. The negative electrode active material may have a volume that changes with charging and discharging, and may have, for example, an expansion coefficient of 5% or more (a volume that changes by 5% or more in comparison between before and after expansion). Among them, the negative electrode active material containing Si has a large volume change due to charging and discharging of the secondary battery 10. That is, when the negative electrode 12 includes an active material whose volume changes with charging and discharging, and a granulated body containing an inorganic solid electrolyte and an alkali metal-containing salt, and the active material includes Si, it is considered that more remarkable effects can be obtained by the system 100 of the present disclosure. Only one type of the negative electrode active material may be used alone, or two or more types may be used in combination. The negative electrode active material may be, for example, in a particulate form, and the size thereof is not particularly limited. The particles of the negative electrode active material may be solid particles, hollow particles, or particles having voids (porous particles). The particles of the negative electrode active material may be primary particles or secondary particles in which a plurality of primary particles is aggregated. The mean particle size (D50) of the particles of the negative electrode active material may be more than 1 nm, more than 5 nm, or more than 10 nm, and may be not less than 500 μm, not more than 100 μm, not more than 50 μm, or not more than 30 μm.

The granulated body, the inorganic solid electrolyte, the alkali metal-containing salt, the conductive auxiliary agent, the binder, and the like that can be included in the negative electrode active material layer 12a may be appropriately selected from those exemplified as those that can be included in the positive electrode active material layer described above, for example. The granulated body, the inorganic solid electrolyte, the alkali metal-containing salt, the conductive auxiliary agent, the binder, and the like included in the negative electrode active material layer 12a may be the same type as those that can be included in the positive electrode active material layer 11a, or may be of a different type.

Any of the negative electrode current collector 12b generally used as a negative electrode current collector of a secondary battery can be adopted. The negative electrode current collector 12b may be a foil, a plate, a mesh, a punching metal, a foam, or the like. The negative electrode current collector 12b may be a metal foil or a metal mesh, or may be a carbon sheet. In particular, the metal foil is excellent in handling properties and the like. The negative electrode current collector 12b may be formed of a plurality of foils or sheets. The negative electrode current collector 12b may be made of Cu, Ni, Cr, Au, Pt, Ag, Al, Fe, Ti, Zn, Co, stainless-steel, or the like. In particular, the negative electrode current collector 12b may contain at least one metal selected from Cu, Ni and stainless steel, from the viewpoint of ensuring reduction resistance and from the viewpoint of difficulty in alloying with lithium. The negative electrode current collector 12b may include a plurality of coating layers for adjusting the resistivity thereof. The negative electrode current collector 12b may be formed by plating or depositing the metal on a metal foil or a base material. When the negative electrode current collector 12b is formed of a plurality of metal foils, some layers may be provided between the plurality of metal foils. The thickness of the negative electrode current collector 12b is not particularly limited. For example, the thickness may be 0.1 μm or more or 1 μm or more, or may be 1 mm or less or 100 μm or less.

### 1.1.3 Electrolyte Layer

The electrolyte layer 13 is disposed between the positive electrode 11 and the negative electrode 12, and can function as a separator. The electrolyte layer 13 includes at least a solid electrolyte, and may optionally include a binder or the like. The electrolyte layer 13 may further contain various additives. The content of each component in the electrolyte layer 13 is not particularly limited, and may be appropriately determined according to the desired battery performance. The shape of the electrolyte layer 13 is not particularly limited, and may be, for example, a sheet shape having a substantially flat surface. The thickness of the electrolyte layer 13 is not particularly limited, and may be, for example, 0.1 μm or more or 1 μm or more, and may be 2 mm or less or 1 mm or less.

The solid electrolyte, the binder, and the like included in the electrolyte layer 13 may be appropriately selected from those exemplified as the electrolyte, the binder, and the like that may be included in the positive electrode active material layer 11a and the negative electrode active material layer 12a described above.

### 1.1.4 Other Configurations

In the secondary battery 10, each of the above-described configurations may be accommodated in an exterior body. As the exterior body, any known exterior body of the battery can be adopted. For example, an exterior body made of a laminate film may be employed. The secondary battery 10 may include a plurality of positive electrodes 11, a plurality of negative electrodes 12, or a plurality of electrolyte layers 13. Further, the plurality of secondary batteries 10 may be electrically connected to each other, and may be arbitrarily overlapped to form a battery pack. In this case, the assembled battery may be housed inside a known battery case. The secondary battery 10 may have an obvious configuration such as a necessary terminal. As the shape of the secondary battery 10, for example, coin-type, laminate-type, cylindrical, and square-type, and the like.

### 1.2 Heating Device

As shown in FIG. 1, the secondary battery system 100 includes a heating device 20. The object to be heated by the heating device 20 includes the alkali metal-containing salt described above. In other words, the heating device 20 may be configured to be capable of heating at least an alkali metal-containing salt. The heating device 20 may be configured to heat at least the positive electrode 11 of the secondary battery 10, may be configured to heat at least the negative electrode 12, and may be configured to heat the entire positive electrode 11, the negative electrode 12, and the electrolyte layer 13 of the secondary battery 10, for example.

The heating method of the heating device 20 is not particularly limited, and any method may be used as long as the method can heat the alkali metal-containing salt to a temperature equal to or higher than the melting point thereof. For example, various methods such as resistance heating, induction heating, dielectric heating, microwave heating, hot air heating, and the like may be employed. The heating device 20 may be configured to be capable of switching between a mode in which the temperature of the alkali metal-containing salt is heated to a temperature equal to or higher than the melting point and a mode in which the temperature of the alkali metal-containing salt is heated or unheated to a temperature lower than the melting point.

The position at which the heating device 20 is installed and the number of the heating devices 20 are not particularly limited. FIG. 1 shows a configuration in which the heating device 20 is disposed on each of the positive electrode 11 side and the negative electrode 12 side. However, the position and number of the heating devices 20 are not limited thereto. The heating device 20 may be disposed inside or outside the exterior body of the secondary battery 10, for example. The heating device 20 may be configured to heat one secondary battery 10 or may be configured to heat a plurality of secondary batteries 10.

The maximum value of the heating temperature by the heating device 20 may be equal to or higher than the melting point of the alkali metal-containing salt. On the other hand, from the viewpoint of suppressing material deterioration of the secondary battery 10 and the like, the heating temperature by the heating device 20 may be 100° C. or less, 90° C. or less, 80° C. or less, 70° C. or less, or 60° C. or less.

### 1.3 Other Configurations

### 1.3.1 Control Device

As illustrated in FIG. 1, the secondary battery system 100 may include a control device 30. The control device 30 controls heating by the heating device 20. The control device 30 may include a CPU, RAM, ROM or the like.

As described above, one or both of the positive electrode 11 and the negative electrode 12 of the secondary battery 10 include a granulated body containing an inorganic solid electrolyte and an active material whose volume changes with charge and discharge. Therefore, when charging and discharging of the secondary battery 10 are repeated, cracks and gaps are likely to occur in the inorganic solid electrolyte due to the volume change of the active material. Such cracks and gaps may cause interruptions in the ion conduction path and the conduction path in the electrode, which may reduce the performance of the secondary battery 10 to a certain level or less. For example, the resistance of the secondary battery 10 increases.

When it is determined that the performance of the secondary battery 10 is equal to or less than a certain level, the control device 30 may control the heating by the heating device 20 so that the temperature of the alkali metal-containing salt becomes equal to or higher than the melting point. The heating time by the heating device 20 is not particularly limited, and may be, for example, a time until the alkali metal-containing salt in the electrode is sufficiently liquefied. For example, the control device 30 may control the switching of ON and OFF of the heating device 20 so that the heating by the heating device 20 is started when it is determined that the performance of the secondary battery 10 is equal to or less than a certain level. Alternatively, the control device 30 may control the heating of the heating device 20 so as to increase the amount of heating by the heating device 20 when it is determined that the performance of the secondary battery 10 is equal to or less than a certain level. As described above, the heating by the heating device 20 is controlled by the control device 30, and the alkali metal-containing salt is heated to a temperature equal to or higher than the melting point thereof, so that the cracks and gaps generated in the positive electrode 11 and the negative electrode 12 can be filled with the alkali metal-containing salt of the liquid. That is, cracks and gaps in the positive electrode 11 and the negative electrode 12 are eliminated by the alkali metal-containing salt. Since the alkali metal-containing salt contains an alkali metal ion, it has a certain alkali metal ion conductivity or conductivity. Therefore, the ion conduction path or the conductive path interrupted by the crack or the gap is connected again via the alkali metal-containing salt. As a result, the performance of the secondary battery 10 is restored.

Whether or not the performance of the secondary battery 10 is equal to or less than a certain level can be determined based on various criteria. For example, when the ion conduction path or the conductive path in the electrode is interrupted, (1) the voltage of the secondary battery at a predetermined SOC is decreased, (2) the resistance of the secondary battery is increased, and (3) the power of the secondary battery is decreased, as compared with a case where the ion conduction path or the conductive path in the electrode is not interrupted. That is, it can be determined whether or not the performance of the secondary battery is equal to or less than a certain level with reference to the voltage, resistance, output, and the like of the secondary battery. For example, as illustrated in FIG. 1, the secondary battery system 100 may include a voltage measurement device as the measurement device 40. The voltage measurement device may measure a voltage of the secondary battery 10. The performance of the secondary battery 10 may be based on the voltage. Specifically, when the voltage of the secondary battery 10 at a predetermined SOC is measured by the voltage measurement device and the voltage measured by the voltage measurement device is equal to or less than a certain value, it is determined that the performance of the secondary battery 10 is equal to or less than a certain value, and the above-described control by the control device 30 may be performed. Alternatively, as shown in FIG. 1, the secondary battery system 100 may include a resistance measurement device as the measurement device 40. The resistance measurement device may measure the resistance of the secondary battery 10. The performance of the secondary battery 10 may be based on the resistance. Specifically, when the resistance of the secondary battery 10 is measured by the resistance measurement device and the resistance value measured by the resistance measurement device is equal to or more than a certain value, it is determined that the performance of the secondary battery 10 is equal to or less than a certain value, and the above-described control by the control device 30 may be performed.

The determination as to whether or not the performance of the secondary battery is equal to or less than a certain level may be performed by, for example, the control device 30 or a device other than the control device 30. The threshold value of whether or not the performance of the secondary battery 10 is equal to or less than a certain level is not particularly limited. An appropriate threshold value may be set according to the performance required for the secondary battery 10.

When it is determined that the performance of the secondary battery 10 exceeds a certain level, the control device 30 may control the heating by the heating device 20 so that the temperature of the alkali metal-containing salt is lower than the melting point. For example, the control device 30 may control the switching of ON and OFF of the heating device 20 so that the heating by the heating device 20 is stopped when it is determined that the performance of the secondary battery 10 exceeds a certain level. Alternatively, the control device 30 may control the heating of the heating device 20 so as to reduce the amount of heating by the heating device 20 when it is determined that the performance of the secondary battery 10 exceeds a certain level.

### 1.3.2 Measurement Device

When the secondary battery system 100 includes a voltage measurement device as the measurement device 40, the voltage measurement device may be any device capable of measuring the voltage of the secondary battery 10. The voltage measurement device may monitor voltages of the plurality of secondary batteries 10. When the secondary battery system 100 includes a resistance measurement device as the measurement device 40, the resistance measurement device may be any device capable of measuring the resistance of the secondary battery 10. The resistance measurement device may monitor the resistance of the plurality of secondary batteries 10. Specific configurations of the voltage measurement device and the resistance measurement device are known. The measurement device 40 may also serve as a voltage measurement device and a resistance measurement device.

### 1.4 Concrete Example of Control Flow

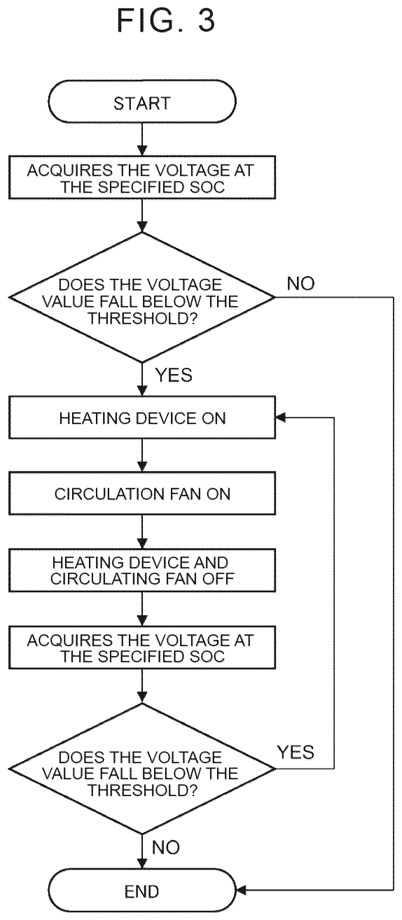

FIG. 3 illustrates a specific example of a control flow in the secondary battery system 100. FIG. 3 is a control flow for determining whether or not the performance of the secondary battery 10 is equal to or less than a certain level with reference to the voltage of the secondary battery 10. As described above, due to the interruption of the ion conduction path or the conduction path in the electrode, the voltage of the secondary battery 10 at a predetermined SOC gradually decreases. The control flow illustrated in FIG. 3 is such that a threshold is set to a voltage value of the secondary battery 10, and when the voltage value is lower than the threshold value, the secondary battery 10 is heated using the heating device 20, the circulation fan, or the like as a ON, and the alkali metal-containing salt contained in the electrode of the secondary battery 10 is heated to a melting point or higher to melt the alkali-metal-containing salt, thereby repairing the solid-solid interface in the electrode.

As shown in FIG. 3, first, the voltage-value of the secondary battery 10 at a predetermined SOC is acquired. The voltage value of the secondary battery 10 can be obtained by the voltage measurement device 40, for example.

When the voltage value of the secondary battery 10 exceeds the threshold value, it is determined that the performance of the secondary battery 10 exceeds a certain value, and the heating control by the heating device 20 is not performed, and for example, the control flow is ended while the heating device 20 remains OFF. On the other hand, when the voltage value is less than the threshold value, it is determined that the performance of the secondary battery 10 is equal to or less than a certain value, and the heating device 20 is turned ON, the circulation fan is turned ON, and the heating of the alkali metal-containing salt by the heating device 20 is started, and the alkali metal-containing salt is liquefied.

After a predetermined period of time, the heating device 20 and the circulation fan are turned OFF, and the voltage of the secondary battery 10 at a predetermined SOC is acquired again. If the voltage is still below the threshold, the heating device 20 and the circulating fan are turned ON again to heat and liquefy the alkali metal-containing salt. On the other hand, when the voltage value exceeds the threshold value, it is determined that the performance of the secondary battery 10 exceeds a certain value, and the control flow is terminated without being heated again by the heating device 20, for example, while the heating device 20 remains OFF.

The control flow in the case where it is determined whether or not the performance of the secondary battery 10 is equal to or less than a certain level with respect to the resistance of the secondary battery 10 may be the same as that in FIG. 3. That is, when the resistivity of the secondary battery 10 is set to a threshold value and the resistance value exceeds the threshold value, the heating device 20, the circulation fan, and the like are turned ON, the secondary battery 10 is heated, and the alkali metal-containing salt contained in the electrode of the secondary battery 10 is heated to a melting point or higher and melted, thereby repairing the solid-solid interface in the electrode.

Specifically, first, the resistance value of the secondary battery 10 is acquired. The resistance value of the secondary battery 10 can be obtained by the resistance measurement device 40, for example.

When the resistance value of the secondary battery 10 is less than the threshold value, it is determined that the performance of the secondary battery 10 exceeds a certain value, and the heating control by the heating device 20 is not performed, and for example, the control flow is ended while the heating device 20 remains OFF. On the other hand, when the resistivity value exceeds the threshold value, it is determined that the performance of the secondary battery 10 is equal to or less than a certain value, the heating device 20 is turned ON, the circulation fan is turned ON, the heating of the alkali metal-containing salt by the heating device 20 is started, and the alkali metal-containing salt is liquefied.

After a certain period of time, the heating device 20 and the circulation fan are turned OFF, and the resistivity of the secondary battery 10 is acquired again. If the resistance value is still above the threshold value, the heating device 20 and the circulating fan are turned ON again to heat and liquefy the alkali metal-containing salt. On the other hand, when the resistance value is less than the threshold value, it is determined that the performance of the secondary battery 10 exceeds a certain value, and the heating device 20 does not perform heating again, for example, the heating device 20 remains OFF, and the control flow is ended.

### 2. Method for Recovering Performance of Secondary Battery

As described above, according to the secondary battery system 100, it is possible to recover the performance of the secondary battery 10 by eliminating the interruption of the ion conduction path and the conduction path in the positive electrode 11 and the negative electrode 12 of the secondary battery 10. In this regard, the technology of the present disclosure also has an aspect as a method for recovering performance of a secondary battery. That is, the performance recovery method of the secondary battery of the present disclosure includes:
Determining whether the performance of the secondary battery is less than or equal to a certain level; and
When it is determined that the performance of the secondary battery is equal to or less than a certain value, a process of recovering the performance of the secondary battery is performed.
the secondary battery includes a positive electrode and a negative electrode;
One or both of the positive electrode and the negative electrode includes an active material and a granulated body,
the active material contains a material of which volume changes as the secondary battery is charged and discharged;
The granulated body includes an inorganic solid electrolyte and an alkali metal-containing salt,
The process of recovering the performance of the secondary battery includes heating the alkali metal-containing salt contained in one or both of the positive electrode and the negative electrode of the secondary battery to a temperature equal to or higher than a melting point of the alkali metal-containing salt.

Details of the criterion for determining whether or not the performance of the secondary battery is equal to or less than a certain level, and details of the heating control for recovering the performance of the secondary battery are as described in the secondary battery system.

As described above, according to the technology of the present disclosure, the interruption of the ion conduction path and the conduction path in the positive electrode and the negative electrode is eliminated, and the performance of the secondary battery can be recovered. In addition, the technology of the present disclosure can also be expected to have an effect of suppressing or repairing cracking of the electrolyte layer and dendrite short-circuiting of the negative electrode.

### 3. Method for Manufacturing Secondary Battery

The technology of the present disclosure also has an aspect as a method of manufacturing a secondary battery. That is, the method for manufacturing a secondary battery of the present disclosure includes obtaining a granulated body containing an inorganic solid electrolyte and an alkali metal-containing salt, mixing the granulated body and an active material to obtain an electrode composite, and forming one of a positive electrode and a negative electrode using the electrode composite.

The granulated body can be obtained, for example, by mixing the above-mentioned inorganic solid electrolyte and an alkali metal-containing salt. The mixing may be performed by a known mixing method. The inorganic solid electrolyte and the alkali metal-containing salt may be mixed using, for example, a mechanical mixing means, or may be mixed manually using a mortar or the like. The mixing temperature, the mixing time, and the mixing atmosphere are not particularly limited, and may be any temperature, time, or atmosphere capable of appropriately granulating the inorganic solid electrolyte or the alkali metal-containing salt. In particular, when the inorganic solid electrolyte and the alkali metal-containing salt are mixed, the inorganic solid electrolyte and the alkali metal-containing salt are easily granulated appropriately by heating. For example, when the inorganic solid electrolyte and the alkali metal-containing salt are mixed, they may be heated to a melting point or higher of the alkali metal-containing salt.

The electrode composite can be obtained by mixing the granulated body and the active material described above. The electrode composite may be obtained by mixing an electrolyte other than the granulated body, an alkali metal-containing salt other than the granulated body, a conductive auxiliary agent, a binder, and the like in addition to the granulated body and the active material. As described above, the active material includes a material whose volume changes with charging and discharging of the secondary battery. Conductive assistants and binders are also described above. The mixing may be performed by a known mixing method. The inorganic solid electrolyte and the alkali metal-containing salt may be mixed using, for example, a mechanical mixing means, or may be mixed manually using a mortar or the like. There is no particular limitation on the mixing temperature, the mixing time, and the mixed atmosphere, and any suitable temperature, time, and atmosphere for obtaining the electrode composite may be used. The electrode composite may be in the form of a slurry or paste. That is, the electrode composite may be obtained by mixing a dispersion medium (for example, an organic solvent) in addition to the granulated body, the active material, optionally an electrolyte other than the granulated body, optionally an alkali metal-containing salt other than the granulated body, optionally a conductive auxiliary agent, and optionally a binder.

One of the positive electrode and the negative electrode can be formed using the electrode composite. For example, a slurry containing an electrode composite is coated on the surface of a current collector and dried, whereby an electrode having a current collector and an active material layer is obtained. The electrode may be a positive electrode or a negative electrode depending on the type of active material included in the electrode composite. The electrode thus obtained can be used to form a secondary battery together with the above-described electrolyte layer and the like. Further, the above-described secondary electronic system can be configured by the secondary battery and the heating device.

As described above, in the method for manufacturing a secondary battery of the present disclosure, the inorganic solid electrolyte and the alkali metal-containing salt are granulated in advance before the electrode composite is obtained, and the other steps may be the same as those known in the art. By granulating the inorganic solid electrolyte and the alkali metal-containing salt in advance, the alkali metal-containing salt is disposed in the vicinity of the inorganic solid electrolyte in the electrode of the secondary battery. Thus, for example, even if the volume change of the active material occurs with charge and discharge of the secondary battery, and cracks or gaps occur in the inorganic solid electrolyte due to the volume change, the alkali metal-containing salt close to the inorganic solid electrolyte is heated and melted by the above-described heating device, so that the cracks or gaps generated in the inorganic solid electrolyte can be repaired by the alkali metal-containing salt.

Hereinafter, the technology of the present disclosure will be described in more detail with reference to examples. However, the technology of the present disclosure is not limited to the following examples.

### 1. Preparation of Positive Electrode

A positive electrode composite containing a NCA positive electrode active material, a sulfide-based solid electrolyte, a vapor-grown carbon fiber, a PVdF binder, and butyl butyrate was stirred by an ultrasonic dispersing device to prepare a positive electrode slurry. Here, the weight ratio of NCA positive electrode active material: the sulfide-based solid electrolyte:the vapor deposition method carbon fiber:PVdF binder was set to 100:16:2:0.75. The positive electrode slurry was coated on a Al foil as a positive electrode current collector foil by a blade method, and dried on a hot plate at 100° C. for 30 minutes to obtain a positive electrode having a positive electrode active material layer and a positive electrode current collector foil.

### 2. Production of Li Containing Salts

Tetrabutylammonium bis(trifluoromethanesulfonyl)amide (TBA-TFSA) and lithium bis(trifluoromethanesulfonyl)amide (Li-TFSA) were heated and mixed in a molar ratio of 1:1 to prepare a Li containing salt. The melting point of the resulting Li content was 56° C.

### 3. Preparation of the Negative Electrode

### 3.1 Comparative Example 1

After mixing the vapor-grown carbon fiber, BR binder, and the mesitylene with a homogenizer, the sulfide-based solid electrolyte and Li containing salt were added and mixed with a homogenizer, and finally, the powder Si was added and stirred with a homogenizer, whereby a negative electrode slurry was prepared. Here, the powder Si:sulfide-based solid electrolyte:Li containing salt:vapor phase growth method carbon fiber:BR based binder weight ratio was 100:54:11.5:8:2. The negative electrode slurry was coated on a Cu foil as a negative electrode current collector foil by a blade method, and dried on a hot plate at 100° C. for 30 minutes to obtain a negative electrode having a negative electrode active material layer and a negative electrode current collector foil.

### 3.2 Comparative Example 2

At the same weight ratio as in Comparative Example 1, the powder Si and Li containing salt were mixed in a mortar while being heated to 60° C., and a granulated body of Si and Li containing salt was obtained. The granulated body was charged and stirred at the same timing as the powder Si of Comparative Example 1 to obtain a negative electrode slurry. By coating and drying the negative electrode slurry in the same manner as in Comparative Example 1, a negative electrode having a negative electrode active material layer and a negative electrode collector foil was obtained.

### 3.3 Example 1

At the same weight ratio as in Comparative Example 1, the sulfide-based solid electrolyte and Li containing salt were mixed in a mortar while being heated to 60° C., and a granulated body of the sulfide-based solid electrolyte and Li containing salt was obtained. The granulated body was charged and stirred at the same timing as the sulfide-based solid electrolyte of Comparative Example 1 to obtain a negative electrode slurry. In the same manner as in Comparative Example 1, the negative electrode slurry was coated and dried to obtain a negative electrode having a negative electrode active material layer and a negative electrode collector foil.

### 3.4 Example 2

After Li containing salt was dissolved in butyl butyrate, a sulfide-based electrolyte was added so as to have the same weight ratio as that of Comparative Example 1, mixed in a mortar, and dried at 100° C. to obtain a granulated body of the sulfide-based solid electrolyte and Li containing salt. The granulated body was charged and stirred at the same timing as the sulfide-based solid electrolyte of Comparative Example 1 to obtain a negative electrode slurry. A negative electrode having a negative electrode active material layer and a negative electrode collector foil was obtained by coating and drying the negative electrode slurry in the same manner as in Comparative Example 1.

### 4. Preparation of Electrolyte Layer

An electrolyte mixture containing a sulfide-based solid electrolyte, a PVdF binder, and butyl butyrate was stirred by an ultrasonic dispersing device to prepare an electrolyte slurry. Here, the weight ratio of the sulfide-based solid electrolyte to PVdF binder was set to 99.6:0.4. The electrolyte slurry was coated on an Al foil as a substrate by a blade method, and dried on a hot plate at 100° C. for 30 minutes to form solid-electrolyte layers on Al foil.

### 5. Preparation of the First Laminate

After laminating the positive electrode and the solid electrolyte layer so as to overlap, after pressing at a 50 kN/cm press pressure and 160° C. in a roll press, peeling Al foil from the solid electrolyte layer, by punching to a size of 1 cm², the first laminate was obtained.

### 6. Preparation of the Second Laminate

After laminating the negative electrode and the solid electrolyte layer so as to overlap, after pressing at a 30 kN/cm press pressure and room temperature in a roll press, peeling Al foil from the solid electrolyte layer, the second laminate was obtained.

### 7. Preparation of the Third Laminate

A third laminate having an additional solid electrolyte layer was obtained by laminating an additional solid electrolyte layer to the solid electrolyte layer of the second laminate so that the additional solid electrolyte layer was overlapped, and then temporarily pressing at a 100 MPa press pressure and a temperature of 25° C. using a flat uniaxial press machine, peeling Al foil from the additional solid electrolyte layer, and punching it to a size of 1.08 cm².

### 8. Preparation of Battery Stack

The first laminate and the third laminate were laminated so that the solid electrolyte layers were overlapped with each other, and then pressed by a flat uniaxial press at a 400 MPa press pressure and a temperature of 135° C., to obtain a battery laminate having a positive electrode, a solid electrolyte layer, and a negative electrode in this order.

### 9. Battery Stack Restraint

The battery stack obtained as described above was sandwiched between two restraining plates, and the two restraining plates were fastened by fasteners at 2 MPa restraining pressures to fix the distance between the two restraining plates.

### 10. Charge/Discharge

The restrained battery stack was charged and discharged three times under the following conditions.
Charging: After constant current charging up to 1/10C, 3.7 V, constant voltage charging up to 3.7 V and end current 1/100C was performed.
Discharge: After constant current discharge to 1/10C, 2.7 V, constant voltage discharge to 2.7 V and end current 1/100C was performed.

### 11. Heating and Resistance Measurement

Resistance measurement before heating and resistance measurement after heating were performed under the following conditions for the battery stack after charging and discharging, and the resistance increase rate was calculated. The resistance increase rate is calculated as [(resistance value after heating)/(resistance value before heating)]×100. Resistance measurement before heating: The constrained battery stack was left in a 25° C. thermostatic bath for 4 hours. Thereafter, constant-current charging up to 3.14 V and constant-voltage charging up to the termination current 1/100C were performed. After that, a 3 C was discharged for 10 seconds. The voltage drop after 10 seconds was divided by the current, and the resistance value before heating was calculated.

Resistance measurement after heating: The restrained battery stack was left in a thermostat at 60° C. for 4 hours to heat the battery stack. Thereafter, the resistance value after heating was calculated in the same manner as the resistance measurement before heating.

### 12. Results

Table 1 below shows the results of the resistivity increase rate of the battery stack for each of Comparative Examples 1 and 2 and Examples 1 and 2.

TABLE 1

| | Comparative | Comparative | | |
|---|---|---|---|---|
| | Example 1 | Example 2 | Example 1 | Example 2 |
| Resistance | 137.7 | 632.9 | 88.6 | 80.1 |
| increase | | | | |

From the results shown in Table 1, it can be said that the secondary battery system having the following configurations (1) to (3) can recover the performance of the secondary battery by heating even when cracks or gaps occur in the solid electrolyte due to the volume change of the active material caused by charging and discharging of the secondary battery, and the performance of the secondary battery deteriorates (for example, the resistance of the secondary battery increases).
(1) A secondary battery system includes a secondary battery and a heating device.
(2) The secondary battery includes a positive electrode and a negative electrode, one or both of the positive electrode and the negative electrode includes an active material and a granulated body, the active material includes a material whose volume changes with charging and discharging of the secondary battery, and the granulated body includes an inorganic solid electrolyte and an alkali metal-containing salt.
(3) The object to be heated by the heating device includes the alkali metal-containing salt,

In the above embodiment, a powder Si which is a negative electrode active material is exemplified as an active material whose volume changes with charging and discharging of the secondary battery. However, the technology of the present disclosure is not limited thereto. An active material other than Si may be used as the negative electrode active material as the active material whose volume changes with charging and discharging of the secondary batteries. In addition, a positive electrode active material may be employed as an active material whose volume changes with charging and discharging of the secondary battery.

In the above embodiment, a sulfide-based solid electrolyte is employed as the inorganic solid electrolyte, and a Li containing salt is employed as the alkali metal-containing salt. However, the technology of the present disclosure is not limited thereto. As the inorganic solid electrolyte, a solid electrolyte other than sulfide may be employed, or an alkali metal-containing salt other than Li containing salt may be employed depending on the type of the carrier ion of the secondary battery.

In the above example, a case where a granulated body of an inorganic solid electrolyte and an alkali metal-containing salt is employed as a material constituting the negative electrode composite is exemplified. However, the technology of the present disclosure is not limited thereto. As a material constituting the positive electrode composite, a granulated body of an inorganic solid electrolyte and an alkali metal-containing salt may be employed.

In the above embodiment, a case in which an all-solid-state battery that does not contain a liquid component at room temperature is configured as a secondary battery is exemplified. However, the form of the secondary battery is not limited thereto. The secondary battery may partially contain a liquid component.

What is claimed is:

1. A secondary battery system comprising:
a secondary battery including a positive electrode and a negative electrode; and
a heating device, wherein
one or both of the positive electrode and the negative electrode include an active material and a granulated body,
the active material contains a material of which volume changes as the secondary battery is charged and discharged;
the granulated body contains an inorganic solid electrolyte and an alkali metal-containing salt, and
an object to be heated by the heating device includes the alkali metal-containing salt.

2. The secondary battery system according to claim 1, further comprising a control device, wherein when performance of the secondary battery is determined to be equal to or lower than a certain level, the control device controls heating by the heating device such that a temperature of the alkali metal-containing salt is equal to or higher than a melting point of the alkali metal-containing salt.

3. The secondary battery system according to claim 2, wherein when the performance of the secondary battery is determined to exceed the certain level, the control device controls heating by the heating device such that the temperature of the alkali metal-containing salt is lower than the melting point of the alkali metal-containing salt.

4. The secondary battery system according to claim 2, further comprising a voltage measurement device, wherein:
the voltage measurement device measures a voltage of the secondary battery; and
the performance of the secondary battery is based on the voltage.

5. The secondary battery system according to claim 2, further comprising a resistance measurement device, wherein:
the resistance measurement device measures a resistance of the secondary battery; and
the performance of the secondary battery is based on the resistance.

6. The secondary battery system according to claim 1, wherein the alkali metal-containing salt has a melting point of 100° C. or less.

7. The secondary battery system according to claim 1, wherein:
the positive electrode contains the active material and the granulated body; and
the active material contains S.

8. The secondary battery system according to claim 1, wherein:
the negative electrode contains the active material and the granulated body; and
the active material contains Si.

9. The secondary battery system according to claim 1, wherein the inorganic solid electrolyte contains a sulfide.

10. The secondary battery system according to claim 1, wherein:
the alkali metal-containing salt includes a first cation and a second cation;
the first cation is at least one selected from an ammonium ion, a phosphonium ion, a pyridinium ion, and a pyrrolidinium ion; and
the second cation is an alkali metal ion.

11. The secondary battery system according to claim 1, wherein:
the alkali metal-containing salt includes a first cation and a second cation;
the first cation is a tetraalkylammonium ion; and
the second cation is an alkali metal ion.

12. The secondary battery system according to claim 10, wherein the alkali metal-containing salt contains at least one anion selected from a group consisting of a halogen ion, a halide ion, a hydrogen sulfate ion, a sulfonylamide ion, and a complex ion containing H.

13. The secondary battery system according to claim 12, wherein:
the alkali metal-containing salt contains one or both of a first anion and a second anion;
the first anion is one or both of a halogen ion and a hydrogen sulfate ion; and
the second anion is a sulfonylamide anion.

14. A manufacturing method of a secondary battery comprising:
obtaining a granulated body containing an inorganic solid electrolyte and an alkali metal-containing salt;
obtaining an electrode composite by mixing the granulated body and an active material; and
forming one of a positive electrode and a negative electrode using the electrode composite.
